(19) United States
(12) Patent Application Publication
(10) Pub. No.: US 2025/0125877 A1
(43) Pub. Date: Apr. 17, 2025

(54) OPTICAL TRANSMITTING APPARATUS, AND CONTROL METHOD

(71) Applicant: NIPPON TELEGRAPH AND TELEPHONE CORPORATION, Tokyo (JP)

(72) Inventors: Ryo MIYATAKE, Musashino-shi, Tokyo (JP); Toshiaki SHITABA, Musashino-shi, Tokyo (JP); Tomoaki YOSHIDA, Musashino-shi, Tokyo (JP); Yoichi FUKADA, Musashino-shi, Tokyo (JP); Akihiro TANABE, Musashino-shi, Tokyo (JP)

(73) Assignee: NIPPON TELEGRAPH AND TELEPHONE CORPORATION, Tokyo (JP)

(21) Appl. No.: 18/685,438

(22) PCT Filed: Aug. 25, 2021
(86) PCT No.: PCT/JP2021/031145

§ 371 Date: Feb. 21, 2024

(51) Int. Cl. H04B 10/548; H04B 10/50; H04J 14/02

(52) U.S. Cl. CPC H04B 10/548; H04B 10/503; H04J 14/0226

(57) ABSTRACT

According to one aspect of the present invention is an optical transmission apparatus including: a division unit configured to divide a frequency-multiplexed input signal into signals with a plurality of bands; a plurality of phase modulators that are allocated to the plurality of bands divided by the division unit and perform phase modulation on the signals with the allocated bands; and a synchronous addition unit configured to synchronously add the signals modulated by the plurality of phase modulators. The input signal may be a multichannel video signal. An output from the same laser diode may be input to each of the plurality of phase modulators.

### TECHNICAL FIELD

The present invention relates to an optical transmission apparatus and a control method.

### BACKGROUND ART

There is an optical transmission apparatus using an FM batch conversion method (see Non Patent Literature 1). A signal generation method in the optical transmission apparatus disclosed in Non Patent Literature 1 will be described with reference to FIG. 12. FIG. 12 is a diagram illustrating a configuration of an optical transmission apparatus. Examples of an input signal A include a BS/CS right-handed IF signal and a BS/CS left-handed IF signal (1.0 to 3.2 GHz). Examples of the input signal B include a CATV signal (90 to 770 MHz). FIG. 13 is a diagram illustrating a signal input to a phase modulator and a frequency of the signal.

As illustrated in FIG. 12, the optical transmission apparatus includes an adder, two narrow line width laser diodes (LDs), a phase modulator, a photo diode (PD), an LD, and an intensity modulator. The input signals A and B are added by an adder and input to the phase modulator. A first narrow line width LD is provided at a stage in front of the phase modulator. A PD is provided at a stage subsequent to the phase modulator and a stage after the second narrow line width LD. A PD and an LD are provided at the front stage of the intensity modulator.

FIG. 14 is a flowchart illustrating a flow of processing of the optical transmission apparatus. When signals are input to the optical transmission apparatus (YES in step S1), the phase modulator performs phase modulation (step S2). Thereafter, the optical signals from the two narrow line widths LD are collectively received by the PD to generate a broadband FM signal (step S3). The broadband FM signal is intensity-modulated by the intensity modulator, and an intensity-modulated result is transmitted to the outside of the optical transmission apparatus (step S4). The processing illustrated in FIG. 14 is performed whenever a signal is input to the optical transmission apparatus.

### CITATION LIST

### Non Patent Literature

Non Patent Literature 1: Toshiaki Shitaba, and four others, “Study on broadband RF signal transmission system using FM batch conversion method by all-channel phase modulation” 2021 IEICE General Conference

### SUMMARY OF INVENTION

### Technical Problem

When the number of channels for a multichannel video signal input to an optical transmission apparatus increases, a frequency of in-phase combination of waveforms on a time axis in each channel signal increases, and a maximum value of instantaneous power of the input signal in a phase modulator increases.

For example, in FIG. 12, the maximum value of the instantaneous power of the signal input to the phase modulator is considerably larger when signals of 400 channels are input to the phase modulator with a bandwidth of 10 GHz than when signals of 130 channels are input to the phase modulator with a bandwidth of 3.2 GHz.

Accordingly, there is a problem that nonlinear conversion occurs in the phase modulator and distortion of an output signal increases.

In view of the foregoing circumstances, an object of the present invention is to provide a technology for inhibiting distortion.

### Solution to Problem

One aspect of the present invention is an optical transmission apparatus including: a division unit configured to divide a frequency-multiplexed input signal into signals with a plurality of bands; a plurality of phase modulators that are allocated to the plurality of bands divided by the division unit and perform phase modulation on the signals with the allocated bands; and a synchronous addition unit configured to synchronously add the signals modulated by the plurality of phase modulators.

Another aspect of the present invention is a method of controlling an optical transmission apparatus, the method including: a division step of dividing a frequency-multiplexed input signal into signals with a plurality of bands; a plurality of phase modulation steps of performing phase modulation on signals with the allocated bands divided by the division step; and a synchronous addition step of performing synchronous addition on each of the signals modulated by the plurality of phase modulation steps.

### ADVANTAGEOUS EFFECTS OF INVENTION

According to the present invention, distortion can be inhibited.

### BRIEF DESCRIPTION OF DRAWINGS

FIG. 1 is a block diagram illustrating a configuration of an optical transmission apparatus.

FIG. 2 is a diagram illustrating a frequency of a signal input to a band division unit.

FIG. 3 is a diagram illustrating a band of a divided signal A.

FIG. 4 is a diagram illustrating a band of a divided signal B.

FIG. 5 is a diagram illustrating a band of a divided signal C.

FIG. 6 is a diagram illustrating sidebands of a broadband FM signal of a divided signal X.

FIG. 7 is a diagram illustrating sidebands of a broadband FM signal of a divided signal Y.

FIG. 8 is a diagram illustrating sidebands of a broadband FM signal of a divided signal Z.

FIG. 9 is a flowchart illustrating a flow of processing of an optical transmission apparatus 100.

FIG. 10 is a diagram illustrating a division example.

FIG. 11 is a diagram illustrating a division example.

FIG. 12 is a diagram illustrating a signal generation method in an optical transmission apparatus of the related art.

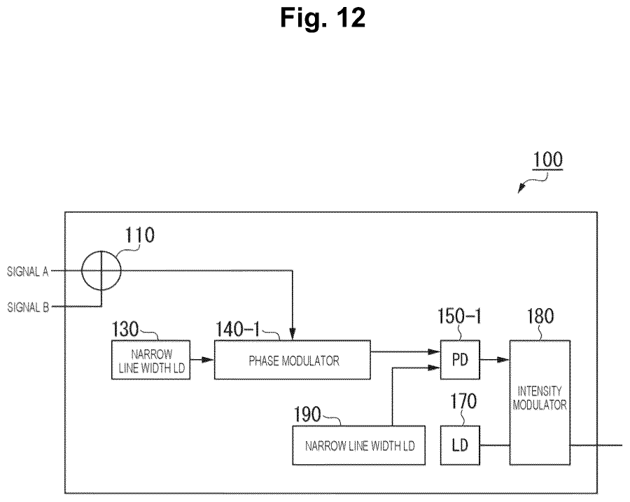

FIG. 13 is a diagram illustrating a signal input to a phase modulator and a frequency of the signal.

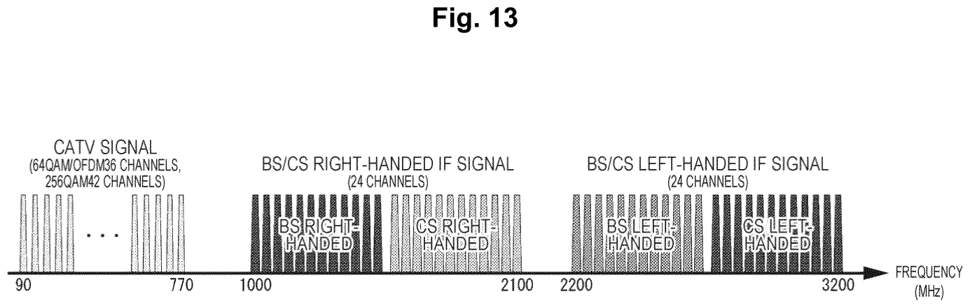

FIG. 14 is a flowchart illustrating a flow of processing of an optical transmission apparatus of the related art.

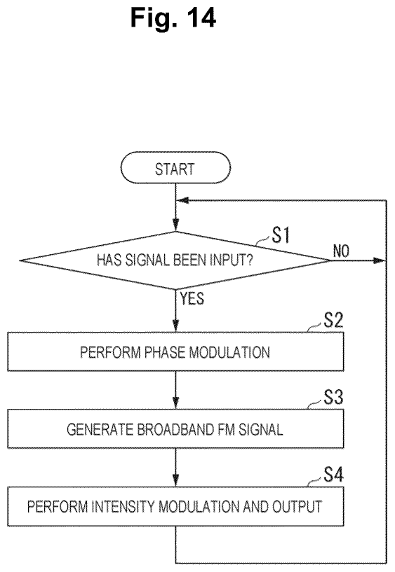

### DESCRIPTION OF EMBODIMENTS

Embodiments of the present invention are described below in detail with reference to the drawings.

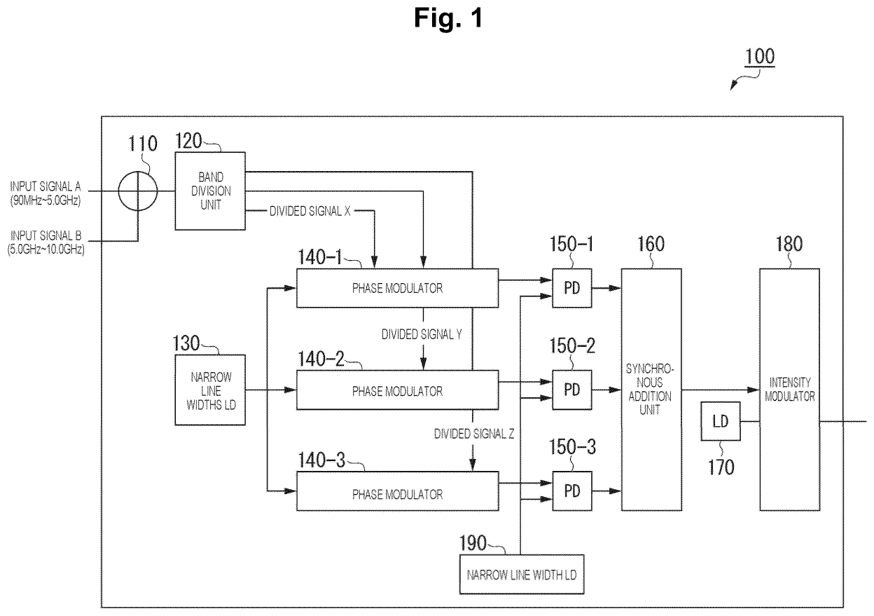

FIG. 1 is a block diagram illustrating a configuration of an optical transmission apparatus 100 according to an embodiment. The optical transmission apparatus 100 includes an adder 110, a band division unit 120, narrow line width laser diodes (LDs) 130 and 190, phase modulators 140-1, 140-2, and 140-3, photo diodes (PDs) 150-1, 150-2, and 150-3, a synchronous addition unit 160, and an intensity modulator 180. Hereinafter, when the phase modulators 140-1, 140-2, and 140-3 are not particularly distinguished from each other, the phase modulators 140-1, 140-2, and 140-3 are referred to as a “phase modulator 140” with reference signs partially omitted. When the PDs 150-1, 150-2, and 150-3 are not particularly distinguished from each other, the PDs 150-1, 150-2, and 150-3 are referred to as “PDs 150” with reference signs partially omitted.

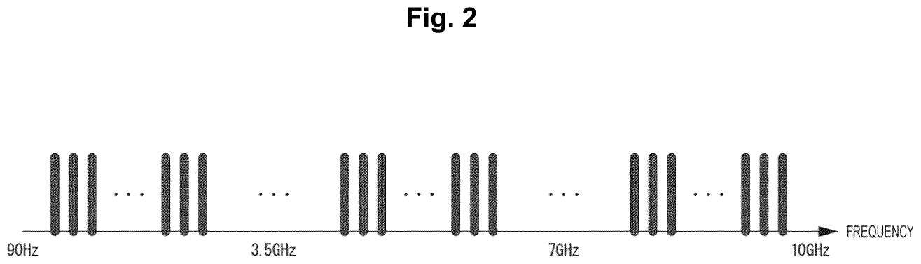

The optical transmission apparatus 100 receives input signals A and B. The input signals A and B are, for example, multichannel video signals. The input signal A is a signal with a band of 90 MHz to 5.0 GHz. The input signal B is a signal with a band of 5.0 GHz to 10.0 GHz. The adder 110 outputs a signal obtained by adding the input signals A and B to the band division unit 120. FIG. 2 is a diagram illustrating a frequency of a signal input to the band division unit 120. FIG. 2 illustrates frequency-multiplexed signals with the band 90 MHz to 10.0 GHz. In this way, a signal with a bandwidth of 10 GHz is input to the band division unit 120. The number of channels is, for example, 400.

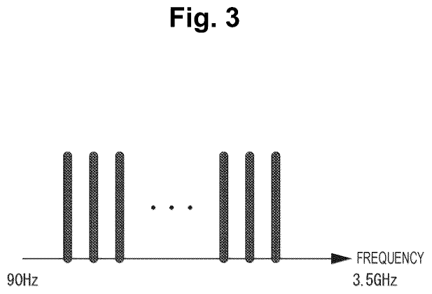

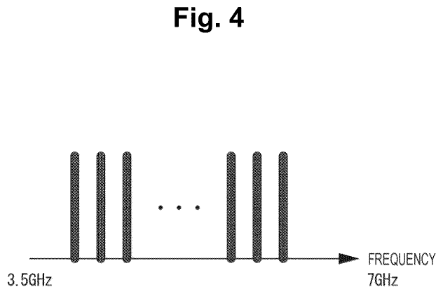

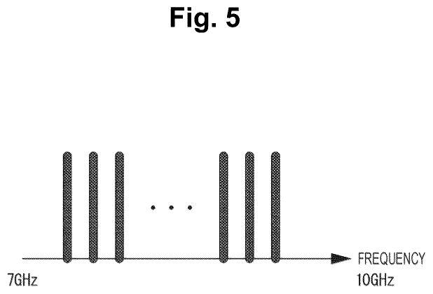

The band division unit 120 divides an input signal into each of three signals. That is, the band division unit 120 divides a signal into a plurality of pieces on a frequency axis. In the embodiment, the band division unit 120 divides the signal into a divided signal X with 90 MHz to 3.5 GHz, as illustrated in FIG. 3, a divided signal Y with 3.5 GHz to 7.0 GHz, as illustrated in FIG. 4, and a divided signal Z with 7.0 GHz to 10.0 GHz, as illustrated in FIG. 5.

The divided signal X is input to the phase modulator 140-1. The divided signal Y is input to the phase modulator 140-2. The divided signal Z is input to the phase modulator 140-3. The phase modulator 140 performs phase modulation on a signal with a band allocated for each of the plurality of bands divided by the band division unit 120.

A band of 90 MHz to 3.5 GHz is allocated to the phase modulator 140-1, and the divided signal X is input. A band of 3.5 GHz to 7.0 GHz is allocated to the phase modulator 140-2, and the divided signal Y is input. A band of 7.0 GHz to 10.0 GHz is allocated to the phase modulator 140-3, and the divided signal Z is input. The output from the narrow line width LD 130 (a narrow line width laser diode) is input to the phase modulator 140. In this way, an output from the same narrow line width LD 130 is input to each of the plurality of phase modulators 140. The corresponding frequencies of the phase modulator 140 are all the same and are 0 Hz to 10 GHz.

An optical signal output from the phase modulator 140-1 is received by the PD 150-1. An optical signal output from the phase modulator 140-1 and an output from the narrow line width LD 190 are collectively received by the PD 150-1 to generate a broadband FM signal of the divided signal X. An optical signal output from the phase modulator 140-2 and an output from the narrow line width LD 190 are collectively received by the PD 150-2 to generate a broadband FM signal of the divided signal Y. An optical signal output from the phase modulator 140-3 and an output from the narrow line width LD 190 are collectively received by the PD 150-3 to generate a broadband FM signal of the divided signal Z.

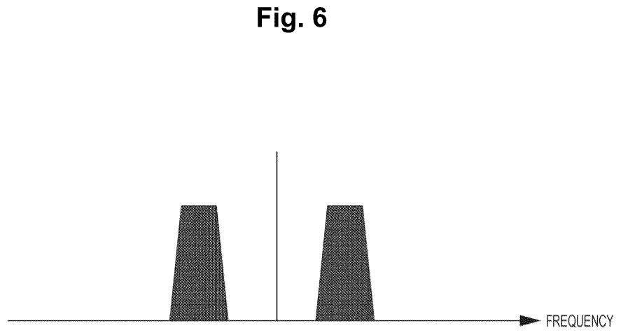

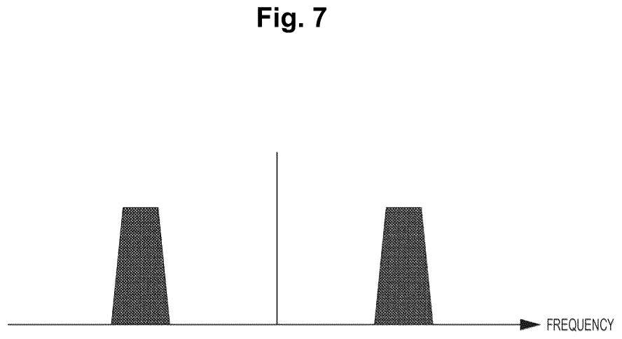

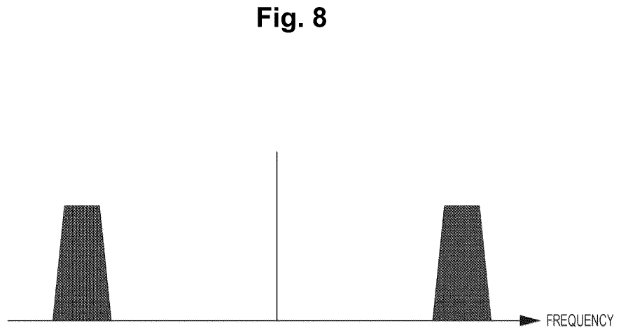

The PD 150 outputs the broadband FM signal to the synchronous addition unit 160. FIG. 6 is a diagram illustrating sidebands of the broadband FM signal of the divided signal X output from the PD 150-1. FIG. 7 is a diagram illustrating sidebands of the broadband FM signal of the divided signal Y output from the PD 150-2. FIG. 8 is a diagram illustrating sidebands of the broadband FM signal of the divided signal Z output from the PD 150-3. As described above, since the frequency bands of side waves are different, it is possible to multiplex these broadband FM signals.

The synchronous addition unit 160 performs addition in a state in which time synchronization (timing synchronization) of the three broadband FM signals is performed using a delay line or the like. The synchronous addition unit 160 outputs an addition signal to the intensity modulator 180. The LD 170 outputs an optical signal to the intensity modulator 180. The intensity modulator 180 performs intensity modulation on the addition broadband FM signal. An intensity modulation result (intensity modulation signal) is output from the optical transmission apparatus 100.

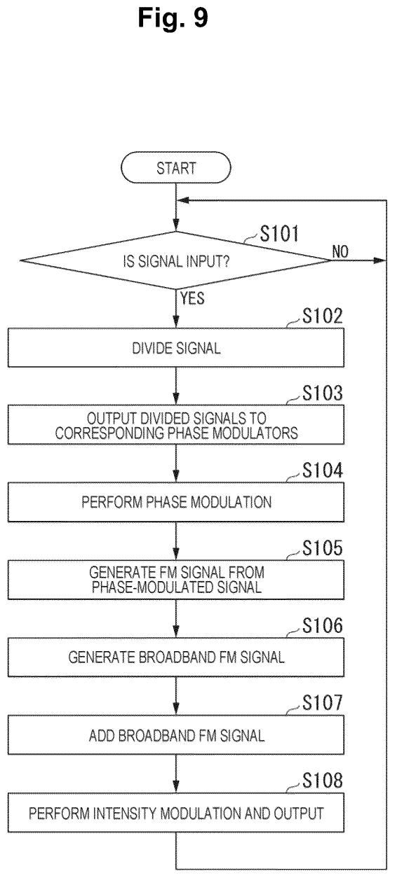

FIG. 9 is a flowchart illustrating a flow of processing of the optical transmission apparatus 100. When a signal is input to the optical transmission apparatus 100 (YES in step S101), the band division unit 120 divides the input signal (step S102). The band division unit 120 outputs the divided signals which have been divided to the phase modulator 140 corresponding to the allocated bands (step S103).

The phase modulator 140 performs phase modulation (step S104). The optical signal output from the phase modulator 140 and the output from the narrow line width LD 190 are collectively received by the PD 150 to generate a broadband FM signal of the divided signal (step S105). The synchronous addition unit 160 adds the broadband FM signal of the divided signal (step S107). The intensity modulator 180 performs intensity modulation on the addition broadband FM signal. The intensity modulator 180 outputs a result of the intensity modulation to the outside of the optical transmission apparatus (step S108).

In the optical transmission apparatus 100, the number of channels input for each of the plurality of phase modulators is smaller than in the optical transmission apparatus including one phase modulator as in the technology of the related art. As a result, the frequency of in-phase combination of waveforms on the time axis in each channel signal is minimized. Since a maximum value of instantaneous power of the input signal in the phase modulator is also minimized, distortion can be inhibited further in the optical transmission apparatus 100 than in the technology of the related art.

After the PD 150 receives the light, signals having different frequencies subjected to FM conversion independently are added and combined in the synchronous addition by the synchronous addition unit 160. It has been confirmed by simulation that a signal obtained through the addition combination can be demodulated by a video-optical network unit (V-ONU) that has received the signal. A configuration of the optical reception apparatus (V-ONU) used in this simulation is similar to the configuration of the optical reception apparatus described in Reference Literature 1 (Toshiaki Shitaba and two others, “Optical Video Transmission Technique using FM conversion”, IEICE Technical Report CS 2019-84, IE 2019-64 (2019-12)). As described above, since the feature that the optical reception apparatus can perform demodulation is used, the optical reception apparatus can restore an original signal from a signal transmitted from the optical transmission apparatus 100.

Further, in the optical transmission apparatus 100, the number of phase modulators 140 is plural, but the same narrow line width LD 130 is shared. Therefore, a frequency error for each LD that is a problem when individual narrow line widths LD are used does not occur in the optical transmission apparatus 100. Frequencies of outputs of the phase modulators 140 are synchronized.

In the above-described embodiment, the number of channels of the input signal is 400 as an example, but any number of channels may be used. The number of band divisions (the number of bands) by the band division unit 120 is three as an example, but may be two or more. Although the corresponding frequency (0 Hz to 10 GHz) is the same in any phase modulator 140, the band of the input signal of each phase modulator may be any band that can be supported by each phase modulator. A supportable band in the phase modulator and a supportable band in another phase modulator may be different.

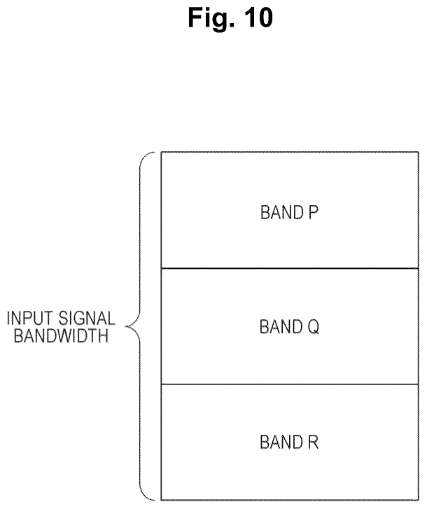

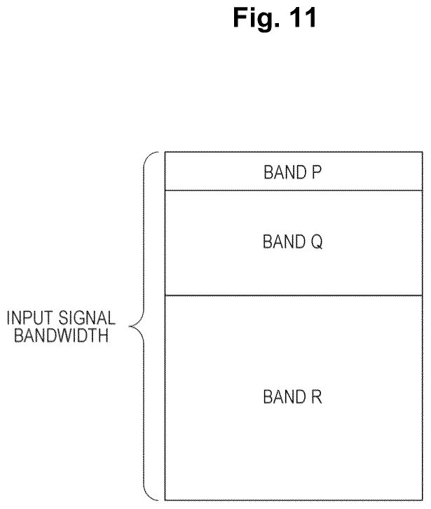

Next, the bands divided by the band division unit 120 will be described. FIGS. 10 and 11 are diagrams illustrating division examples. In FIGS. 10 and 11, the number of divided bands is 3, but may be 2 or more, as described above.

FIG. 10 and FIG. 11 illustrate the divided bands P, Q, and R. As illustrated in FIG. 10, the bands P, Q, and R may be the same bandwidth. As illustrated in FIG. 11, bandwidths of the bands P, Q, and R may be different.

For example, when a signal of the band P is more likely to be distorted than a signal of the band Q and a signal of the band Q is more likely to be distorted than the signal of the band R, as illustrated in FIG. 11, the band in which the signal is more likely to be distorted has a narrower band. The narrower the band is, the smaller the number of signals in the band is. Therefore, distortion is further inhibited. As described above, the plurality of bands may be determined in accordance with a distortion characteristic of each band.

Furthermore, the plurality of bands may be determined in accordance with the number of channels of each band. A band that has a larger number of channels has a narrower band. Accordingly, the narrower the band is, the smaller the number of signals in the band is. Therefore, it is possible to further inhibit the distortion.

In the above-described embodiment, the band division unit 120 and the synchronous addition unit 160 may be configured using a processor such as a central processing unit (CPU) and a memory. In this case, the band division unit 120 and the synchronous addition unit 160 function as the band division unit 120 and the synchronous addition unit 160 when the processor executes a program. All or some of the functions of the band division unit 120 and the synchronous addition unit 160 may be realized by using hardware (electronic circuit or circuitry) such as a large scale integrated circuit (LSI), an application specific integrated circuit (ASIC), a programmable logic device (PLD), or a field programmable gate array (FPGA). The program may be recorded in a computer-readable recording medium (non-transitory recording medium). Examples of the computer-readable recording medium include portable media such as a flexible disk, a magneto-optical disk, a ROM, a CD-ROM, and a semiconductor storage device (a solid state drive (SSD), for example), and storage devices such as a hard disk and a semiconductor storage device built in a computer system. The program may be transmitted via a telecommunication line.

Although the embodiments of the present invention have been described in detail with reference to the drawings, specific configurations are not limited to the embodiments and include design and the like within the scope of the present invention without departing from the gist of the present invention.

### INDUSTRIAL APPLICABILITY

The present invention is applicable to an optical transmission apparatus that transmits multichannel signals.

### REFERENCE SIGNS LIST

100 Optical transmission apparatus
110 Adder
120 Band division unit
130 Narrow line width LD
140, 140-1, 140-2, 140-3 Phase modulator
160 Synchronous addition unit
170 LD
180 Intensity modulator
190 Narrow line width LD

1. An optical transmission apparatus comprising:
a processor; and
a storage medium having computer program instructions stored thereon, when executed by the processor, perform to:
divide a frequency-multiplexed input signal into signals with a plurality of bands;
and
synchronously add the signals modulated by the plurality of phase modulators; and
a plurality of phase modulators that are allocated to the plurality of bands and perform phase modulation on the signals with the allocated bands.

2. The optical transmission apparatus according to claim 1, wherein the input signal is a multichannel video signal.

3. The optical transmission apparatus according to claim 1, wherein an output from the same laser diode is input to each of the plurality of phase modulators.

4. The optical transmission apparatus according to claim 1, further comprising an intensity modulator configured to perform intensity modulation on a signal.

5. The optical transmission apparatus according to claim 1, wherein the plurality of bands are determined in accordance with a distortion characteristic of each band.

6. The optical transmission apparatus according to claim 1, wherein the signal is able to be demodulated by a reception apparatus having received the signal.

7. A method of controlling an optical transmission apparatus, the method comprising:
a division step of dividing a frequency-multiplexed input signal into signals with a plurality of bands;
a plurality of phase modulation steps of performing phase modulation on signals with the allocated bands divided by the division step; and
a synchronous addition step of performing synchronous addition on each of the signals modulated by the plurality of phase modulation steps.
